(19) United States
(12) Patent Application Publication
(10) Pub. No.: US 2010/0174567 A1
(43) Pub. Date: Jul. 8, 2010

(54) MOBILITY ASSISTANCE SYSTEM

(75) Inventors: Anthony Clive King, London (GB); Barbara Ann King, London (GB); Matthew Lievesley, New Castle upon Tyne (GB)

Correspondence Address: LAHIVE & COCKFIELD, LLP;FLOOR 30, SUITE 3000, ONE POST OFFICE SQUARE, BOSTON, MA, 02109, US

(73) Assignee: WWB SERVICES LIMITED, Newcastle upon Tyne (GB)

(21) Appl. No.: 12/444,358

(22) PCT Filed: Oct. 1, 2007
(86) PCT No.: PCT/GB2007/003714

§ 371 Date: Jan. 8, 2010

(30) Foreign Application Priority Data
Oct. 4, 2006 (GB) 0619555.6
Jul. 25, 2007 (GB) 0714505.5

(51) Int. Cl. G07F 11/62; G06K 5/00; G06Q 10/00; G07F 17/12; G07F 7/00

(52) U.S. Cl. 705/5; 235/382; 235/384; 280/200; 705/13

(57) ABSTRACT

Apparatus (1) for enabling temporary access to a wheelchair (15) comprises a number of wheelchair containers (2) and a control unit (5) which communicates with the containers and is arranged to interact with a user to permit release of the wheelchair from the container. Each container may be provided with a reader (16) for an identifier (17) carried by a wheelchair, so that the control unit can record that a wheelchair with that identifier has been released, and record return of that or another wheelchair to the container. The control unit may communicate with the control units of other apparatus at other locations, and/or with a central data processing facility (39). The system may be integrated with a transport reservation system.

This invention relates to a mobility assistance system and is particularly concerned with providing people with access to mobility assistance vehicles such as wheelchairs, mobility scooters, buggies and so forth.

Whilst the invention is particularly advantageous for those who have mobility problems as a result of a disability, injury, or advancing years, it is also of use for people who do not normally have such problems but may encounter them in particular circumstances. A person may not have difficulty walking normally, but may find it tiring to visit all of the sights at a venue such as a park, for example. Nor is the invention restricted to vehicles such as wheelchairs. A parent with small children may find that they become unexpectedly tired during a visit to a venue and may wish for a pushchair, having left their own one in a car for example. Whilst the invention is primarily directed towards the provision of wheelchairs and the like, it encompasses the use of other vehicles whose primary function is the carrying of a person of reduced mobility, having a seat portion and three or more wheels to provide a stable platform. Preferably, the vehicle can be powered by the user's hands and/or by a carer pushing the vehicle. Additionally or alternatively, the vehicle may be provided with a power unit such as an electric motor, with ancillary items such as a battery and controls.

A preferred embodiment of the invention provides an on-location, on-demand wheelchair and mobility aid service, and has been developed primarily to serve the increasing market of those persons with reduced mobility. In a preferred embodiment, the invention increases the opportunities for social inclusion and independence for this sector of the community, enabling them to enjoy facilities and amenities with more pride, more comfort, more ease of access, and for longer periods of time.

Preferred embodiments of the invention are designed to serve almost any outdoor or indoor location—large or small—anywhere groups of people congregate or visit. These include urban centres and retail parks, museums and galleries, parks and arenas, garden centres, railway stations, airports and events.

Viewed from one broad aspect, the invention provides a method of enabling temporary access to a mobility assistance vehicle for a person, and particularly a wheelchair, comprising providing an access unit which includes a container for the vehicle and a control unit, wherein the container includes means for detecting the presence or absence of a vehicle in the container, the presence or absence of a vehicle is recorded by the control unit, and the control unit interacts with a user to permit release of a vehicle from the container, records that the vehicle has been released, and records return of that or another vehicle to the container.

Preferably, the vehicle has a machine readable identifier and the container has a reader for the identifier, and the control unit records that the vehicle with that identifier has been released, and records return of that or another vehicle with an identifier to the container.

Preferably, the interaction between the control unit and the user includes a verification process, in which the user provides the control unit with data that will enable the user to be identified and/or charged for use of the vehicle. This may be done by means of a debit or credit card for example.

Viewed from another aspect, the invention provides apparatus for enabling temporary access to a mobility assistance vehicle for a person, and particularly a wheelchair, comprising an access unit which includes a container for the vehicle and a control unit, the container having means for detecting the presence or absence of a vehicle in the container, and the control unit being adapted to record the presence or absence of a vehicle in the container, wherein the control unit is arranged to interact with a user to permit release of a vehicle from the container, to record that the vehicle has been released, and to record return of that or another vehicle to the container.

Preferably, the container has a reader for a machine readable identifier on a vehicle, and the control unit is configured to record that a vehicle with that identifier has been released, and to record return of that or another vehicle with an identifier to the container. However, in some embodiments the presence of a vehicle in the container may be detected by means of a simple electrical, magnetic, optical or other sensor, or a mechanical device which is activated or deactivated when a vehicle is in the container, which cannot identify which particular vehicle is in the container.

In a preferred embodiment, the container has a door, and the control unit is arranged to control unlocking of the door so as to release a vehicle in the container.

The invention also extends to the apparatus with a vehicle in the container.

The machine readable code could be e.g. a bar code that is read optically. Preferably, however, the code is embedded electronically and communicates in a wireless fashion with the reader via Bluetooth™ or other wireless protocols. In a preferred arrangement the code is embedded in an RFID chip.

In a preferred embodiment, the access unit comprises a plurality of the containers, and a common control unit

In a preferred arrangement, the invention provides a system for enabling temporary access to a mobility assistance vehicle by a person, using one or more access units, each of which comprises a container and a control module; in which:

the container is adapted for containing a mobility assistance vehicle, and is provided with a lockable closure which can be unlocked to provide access to the interior of the container to permit removal and replacement of the mobility assistance vehicle;

the mobility assistance vehicle is provided with machine-readable vehicle identification data, and the container is provided with a reader for the identification data;

the control module (a) is adapted to control unlocking of the container; (b) is provided with a verification system for receiving verification data from a user wishing to have access to the mobility assistance vehicle in the container and (c) receives vehicle identification data from the reader in the container;

wherein:

a user wishing to have access to the mobility assistance vehicle from the access unit provides verification data to the verification system of the control module of the access unit;

in the event of successful verification of the verification data, the control module unlocks the container containing the mobility assistance vehicle;

the user removes the selected mobility assistance vehicle from the unlocked container;

using the vehicle identification data, the control module stores data linking removal of the selected mobility assistance vehicle with data associated with the user;

and

subsequently a user returns an assistance vehicle to the container, the container is locked, and using the vehicle identification data, the control module stores data linking return of the selected mobility assistance vehicle with data associated with that user.

The vehicle that is returned to the container may be the vehicle originally taken from the container or a vehicle taken from another container. The other container may be part of the same access unit, and preferably the access unit comprises a plurality of pads which communicate with the control unit. The other container may be part of another access unit located elsewhere, from which the returned vehicle was originally taken, and again that other access unit may comprise a plurality of containers.

The control unit may be such that a user interacts with the unit when the user returns a mobility access vehicle to a container.

In a preferred arrangement, data is stored that identifies the user of the vehicle, and the fact that the user has taken a vehicle and has returned the vehicle. The data identifying the user may be direct or indirect. Typically the data will be obtained from a card such as a debit or credit card, a season ticket for a venue, a loyalty card for a venue or for a store, and so forth. This may if necessary or desirable be combined with entry of a code such as a PIN, but in some cases the only verification data required will be that which can be obtained from the card. In alternative arrangements, the data identifying the user may have been obtained in another manner, for example from a form filled in over the Internet or information given by telephone, text message or in any other way. Typically, in such arrangements the user will be provided with a code to enter at the control module. However, the user might provide card details, and then use the card as verification to identify the user.

There will be many different ways of identifying a user and controlling access to the system, but in general there should be a way (direct or indirect) of following up a user who has for example damaged or failed to return a vehicle, and of obtaining payment from the user.

Preferably, there is a combination of different ways of gaining access to a vehicle. There could be the possibility of at least some vehicles at an access unit being pre-booked, and at least some being provided as available at the access unit.

In some situations there may be only one access unit, for example inside a specific venue which the vehicles will not leave. Vehicles will be taken from and returned to that access unit. In other situations, there may be a number of access units at a particular venue, and the vehicles can be returned to any of them. In still further situations, there may be a number of access units distributed in a number of different venues, and a vehicle may be taken from one access unit at one venue, and returned to another access unit at another venue. There could, for example, be a supplementary charge for return to another unit and/or venue, the level of which could depend on whether or not arrangements were made in advance.

The arrangement is preferably such that a financial penalty can be imposed under appropriate circumstances. However, whether or not payment has to be made for normal use over an agreed period, will depend on the operators of the system. In some cases, particularly at a venue, the vehicles may be provided free of charge for use at that venue and return within a specified period. In other cases, the vehicles may be charged for at all times.

In the preferred embodiments of the invention, a single control module controls a number of containers, so that transactions can be carried out at a single point. However, in some cases where they might be significant demand over a short period—such as at a sports event—it may be desirable to have a number of control units that can control all of the containers of an access unit, in which case there would be central processing of data, for example one control module being a master unit and one or more other units being slaves.

In any event, a control module could be self contained (except, for example, as regards processing and verifying e.g. credit card details) or could have at least some processing conducted at a remote site by means of a data link, which could be hard wired, or wireless using wi-fi technology, GPRS technology or any other suitable means of wireless data transmission.

The container for the vehicle may be provided with means to carry out various functions on a returned vehicle, such as cleaning, drying, disinfection, the application of a scent or air freshening substance, and so forth so that a subsequent user is presented with a vehicles that is fresh.

The container may be provided with features such as guide rails for assisting insertion of the vehicle into the container and removal from the container. The arrangement may be such as to align small wheels or castors on the vehicle.

In some arrangements, the vehicle is collapsible and is inserted into and removed from the container in a collapsed state. However, the system could be such that the vehicle is provided in a fully erected condition. In one possible arrangement, the vehicle could be stored in a collapsed state, and the container could have means which automatically collapses the vehicles as it is being inserted into the container, and automatically erects the container when the vehicle is removed. The arrangement could be such that the user must firstly partially collapse the vehicle or prepare it for collapse, for example by unfastening one or more safety catches, when returning the vehicle. Similarly, the user may need to complete erection or to secure the vehicle in an erect state, for example by fastening one or more safety catches. The vehicle may be provided with a unit to provide a visual and/or audible warning if a safety catch is not engaged or the vehicle is otherwise not ready for safe use.

In some preferred embodiments, the system uses a machine readable unique identifier for each vehicle, and a reader in the container to identify the vehicle that is being taken out or returned. However, the systems and apparatus could be used without such identifiers. In that case, when a vehicle is to be returned preferably the arrangement is such that the user returning the vehicle enters an identifying code such as the six digit code used when taking the vehicle, or has a bar code scanned, or uses the same credit/debit card. The return transaction will be completed when the user places the vehicle in the container and shuts the door. There may be a simple sensor, mechanical interlock or the like to detect that a vehicle has indeed been placed in the container. In some circumstances, however, it may be sufficient to rely upon the honesty of the users.

Thus viewed from another aspect, the invention provides a method of enabling temporary access to a wheelchair for a person, comprising providing an access unit which includes a plurality of lockable retaining units for a respective plurality of wheelchairs, the access unit including a control unit linked to all of the retaining units, wherein a user interacts with the control unit to provide identification data when desiring access to a wheelchair, the control unit controls unlocking of a retaining unit so as to permit release of a wheelchair from that unit, and the control unit stores data linking supply of the wheelchair to a user associated with identification data.

Viewed from another aspect, the invention provides a method of enabling a user to return a wheelchair after temporary use of the wheelchair by a person, comprising providing an access unit which includes a plurality of lockable retaining units for a respective plurality of wheelchairs, the access unit including a control unit linked to all of the retaining units and controlling locking means for the retaining units, wherein a user interacts with the control unit to provide identification data when returning the wheelchair, the user places the wheelchair in an empty retaining unit, the retaining unit is locked, and the control unit stores data linking return of the wheelchair to a user associated with identification data.

Viewed from another aspect, the invention provides a system for enabling temporary access to a mobility assistance vehicle by a person, using one or more access units, each of which comprises a container and a control module; in which:

the container is adapted for containing a mobility assistance vehicle, and is provided with a lockable closure which can be unlocked to provide access to the interior of the container to permit removal and replacement of the mobility assistance vehicle;

the control module (a) is adapted to control unlocking of the container; and (b) is provided with a verification system for receiving verification data from a user wishing to have access to the mobility assistance vehicle in the container;

wherein:

a user wishing to have access to the mobility assistance vehicle from the access unit provides verification data to the verification system of the control module of the access unit;

in the event of successful verification of the verification data, the control module unlocks the container containing the mobility assistance vehicle;

the user removes the selected mobility assistance vehicle from the unlocked container;

the control module stores data linking removal of a mobility assistance vehicle with data associated with the user;

and

subsequently a user returns the mobility assistance vehicle to the container, provides verification data to the verification system of the control module of the access unit, the container is locked, and the control module stores data linking return of the selected mobility assistance vehicle with data associated with the user.

In preferred embodiments of the invention, the system uses a container which is of particularly advantageous design. The container is particularly suited to operation by a person of limited mobility or strength. The container has a number of novel aspects which are described in more detail, below. One of those aspects concerns the manner in which a door is opened.

Thus viewed from another aspect of the invention, there is provided a container for a mobility assistance vehicle, the container having a body with a front wall and a top wall, and having a door which extends over the top wall and the front wall, wherein the door comprises an upper part and a lower part which are joined together by means of a first transverse hinge, the upper part having a first end portion which is mounted to the body of the container by means of a second transverse hinge, and the lower part having a second end portion provided with means to enable the door to be locked and unlocked to the body portion.

Preferably, the door is provided with a transverse handle extending across the lower part of the door.

Preferably, means are provided for holding the door in an intermediate open position. In a preferred arrangement, a remote unit unlocks the door—for example by providing an electrical signal to an electrically controlled locking mechanism for the door of the container—such that it moves automatically to the intermediate open position.

In a preferred embodiment, the lower part of the door, preferably adjacent the second end portion, is provided with a follower which engages a guide track. The guide track may be provided with a shoulder to define the intermediate open position. Preferably there is a follower and guide track arrangement on both sides of the door. In one preferred arrangement, there is a pair of guide tracks on each side of the container. One guide track on each side is engaged with a follower and controls the movement of the door relative to the body of the container. The other guide track is engaged by a pin, and has a shoulder which is engaged by the pin so as to hold the door in the intermediate, partly open condition.

In general, in a preferred arrangement, the door opens automatically until a member on the door engages an abutment, which holds the door in a partially open condition. Outwards movement of the door relative to the body of the container causes the member to be disengaged from the abutment, so that the door can then be opened fully. Preferably, in all arrangements, opening of the door can be mechanically assisted, for example by means of a one or more gas filled struts, electrically powered devices or the like.

The arrangement is preferably such that upwards movement is limited in the region of the intermediate open position when the door is first opened, pending further opening manipulation by the user to a fully open condition. Similarly, preferably the arrangement is such that downwards movement is limited in the region of the intermediate open position when the door is being closed, pending further closing manipulation by the user to a fully closed condition.

In preferred embodiments, a container as above described has the advantages that a user does not have to back away from the door as it opens, and the door opens within the footprint of the container.

In one preferred embodiment of a system in accordance with the invention, the sequence of events may be as follows.

A central booking system allows booking through Internet, phone and on site.

The Internet booking system, integrated with flight, train, bus, car hire, or hotel booking systems, allows a customer to book a wheelchair from a defined location, and return it to the same or a different location. The booking captures a start date and time and a return date and time.

A booking may be for a wheelchair, a wheelchair with an attendant, a mobility scooter, or other mobility aid.

The Internet booking system preferably has an interactive mapping system that shows the location of all access units across the world, or in selected regions, or at selected sites such as an airport.

The booking system will involve a financial transaction if the wheelchair has to be paid for, typically requiring a debit or credit card authorisation and payment.

Confirmation of booking will issue a booking reference, and optionally a barcode printout for the access units to read.

When a customer arrives at an access unit, clear printed instructions are visible.

If they have pre-booked, the customer (or their carer) enters the pre-booked information by typing in a confirmation code, such as the booking reference, by scanning their printed barcode, by entering their loyalty card or their debit/credit card, by entering their boarding pass, or by other means.

If they have not pre-booked, they make a booking through the access units interface screen, using a touch screen and/or buttons as appropriate. This may involve payment using a credit or debit card or a loyalty card.

The customer will agree to their liability to return the wheelchair within the booked time, and will agree to a penalty for late returns.

The access unit will allow a voice conversation with a control centre in case of difficulty.

Once the booking is confirmed, the appropriate container part-opens under the control of the system. Control is exercised by the use of buttons and touch screen interfaces as appropriate.

The part-open container is fully opened by the customer to release a wheelchair.

The customer has a set period of time to review the chair, and return it for a replacement if it is found to be faulty or unsatisfactory.

Some access units will contain a map browsing system to highlight the local area and identify possible return locations. These details may be printed on demand.

When the customer returns the wheelchair they enter their booking code (for example in the same manner as when taking the wheelchair) to open a container. The container part opens under the control of the system, the user fully opens the container and the wheelchair is replaced. The container is then fully closed. If the time paid for or allowed has been exceeded, the customer will be warned that the appropriate penalty will be exacted.

It will thus be appreciated that the various aspects of the invention provide versatile possibilities for providing wheelchairs or other mobility aids to users. The invention may be viewed from many broad aspects. For example, viewed from one aspect the invention provides a container for storage and dispensing of a vehicle, comprising a door, a locking system for the door, a wireless reader for reading a code stored in a unit on the vehicle, and a control unit for receiving verification data from a user so as to unlock the door and permit removal of the vehicle, and for generating data associating removal of the vehicle with the user.

The invention is of particular use in the context of providing access to wheelchairs at airports. In an airport the means for retaining a wheelchair—or other mobility assistance vehicle—could be simpler given that the wheelchairs may be kept within a sheltered environment such as a terminal building, and that there may be security staff who can ensure that vandalism or theft are prevented. There may be just a simple locking device for each wheelchair, stored for example in a rack, which can be released remotely from a control unit. A user with, for example, a boarding pass, e-ticket or fill ticket could present the item to a scanner for e.g. a printed barcode or the like, to release the wheelchair if a booking for the wheelchair has been made in association with the flight that the user is taking.

Thus viewed from another aspect, the invention provides a method of providing a wheelchair to a person taking transport from a departure point and wishing to have a wheelchair for mobility at the departure point, wherein a booking for the wheelchair at the departure point is linked to a reservation for transport from the departure point, and when the user is at the departure point an identifier for the transport reservation is used to release the wheelchair from a unit which controls access to the wheelchair. It will be appreciated that this aspect is applicable to the release of other mobility assistance vehicles, and to departure points such as airports, railway stations, ferry terminals and the like.

Similarly, viewed from another aspect, the invention provides a method of providing a wheelchair to a person taking transport to an arrival point and wishing to have a wheelchair for mobility at the arrival point, wherein a booking for the wheelchair at the arrival point is linked to a reservation for transport to the arrival point, and when the user is at the arrival point an identifier for the transport reservation is used to release the wheelchair from a unit which controls access to the wheelchair. It will be appreciated that this aspect is applicable to the release of other mobility assistance vehicles, and to arrival points such as airports, railway stations, ferry terminals and the like.

In respect of various aspects of the invention, the control unit may keep all data locally. If there is a plurality of access units, the access units may exchange data with each other and/or with a central data processing system. Thus, the status and location of a wheelchair may be tracked at a venue, in a region of a country, in a country or internationally.

Some embodiments of the invention will now be described by way of example and with reference to the accompanying drawings, in which:

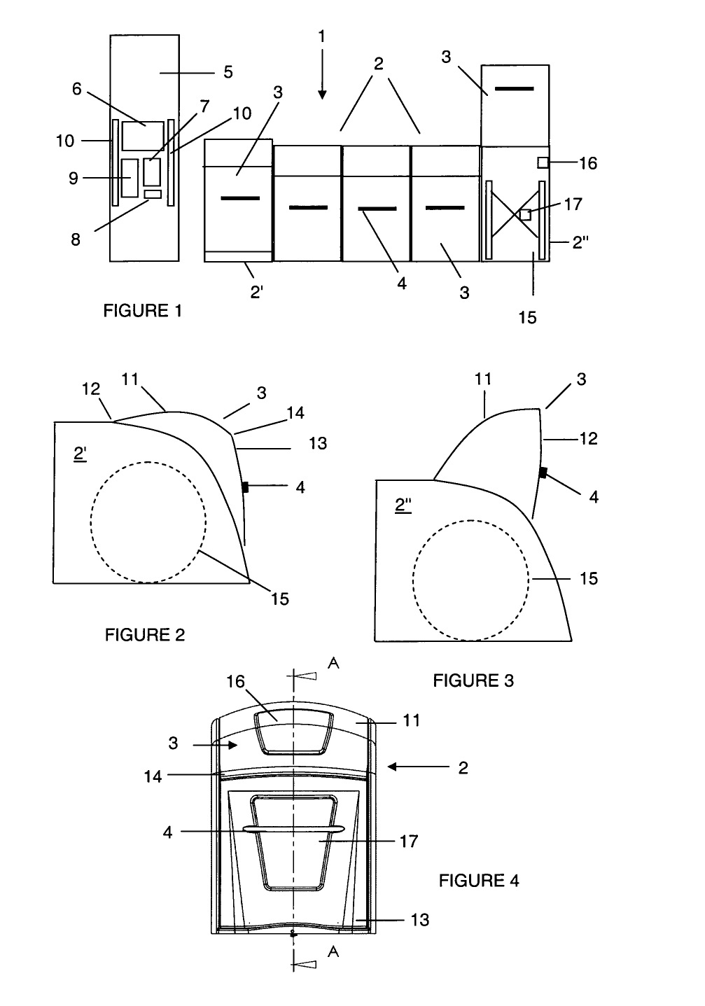

FIG. 1 is a diagrammatic front view of an access unit in accordance with an embodiment of the invention;

FIG. 2 is a diagrammatic side view of a container of the access unit, partially opened;

FIG. 3 is a diagrammatic side view of a container of the access unit, fully opened;

FIG. 4 is a detailed front view of the container;

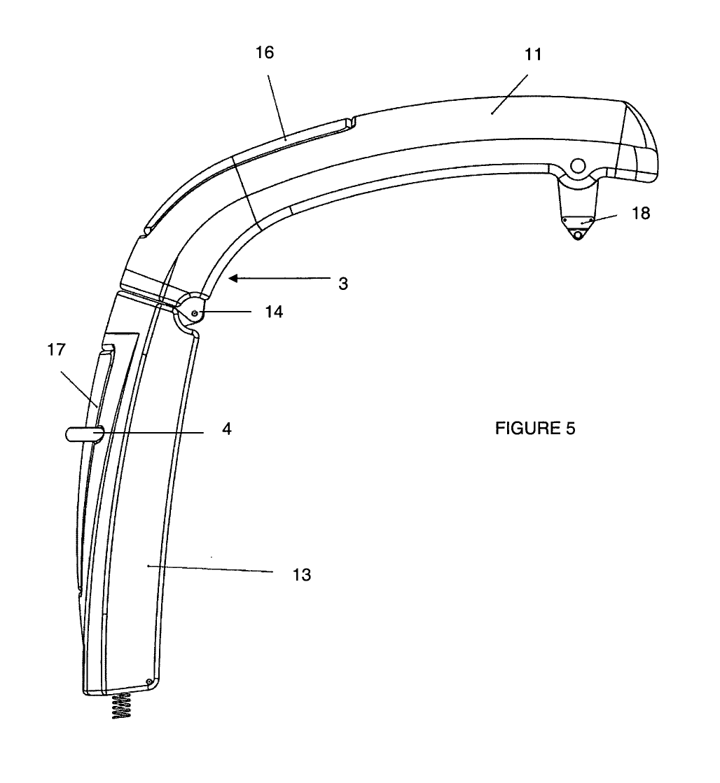

FIG. 5 is a detailed side view of the door of the container;

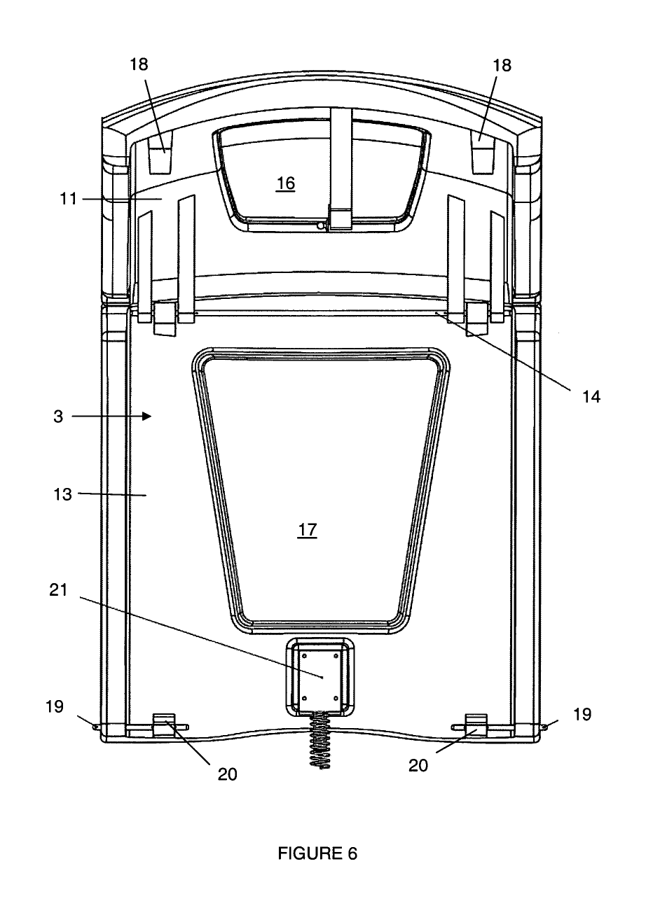

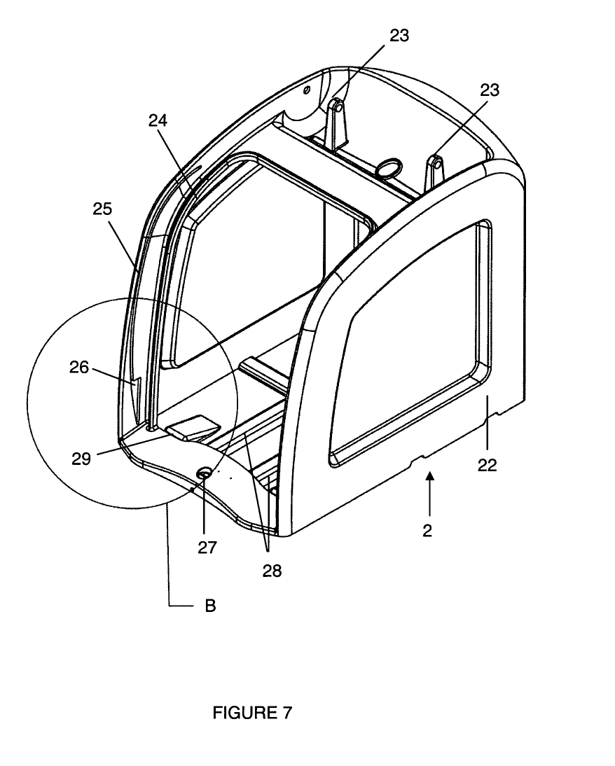

FIG. 6 is a detailed rear view of the door of the container;

FIG. 7 is a detailed perspective view of the main body of the container, with the door removed;

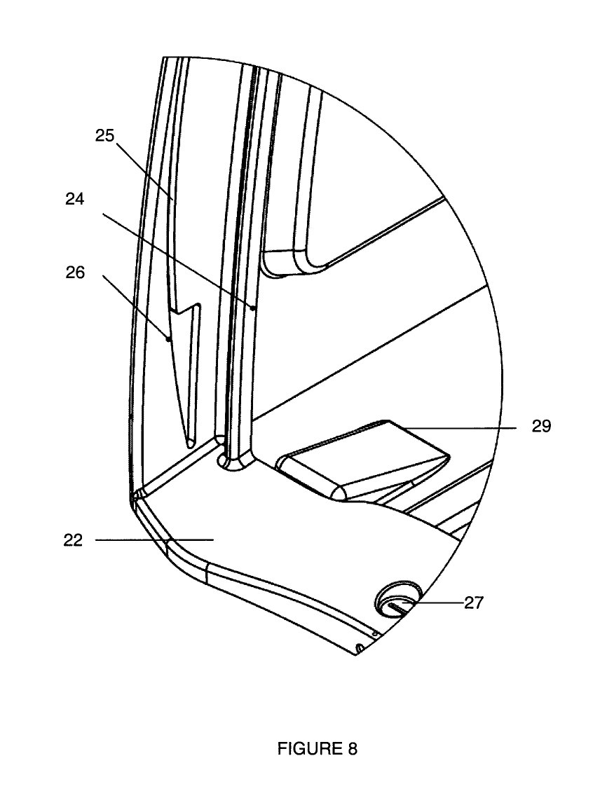

FIG. 8 is a larger scale view of the portion marked B on FIG. 7;

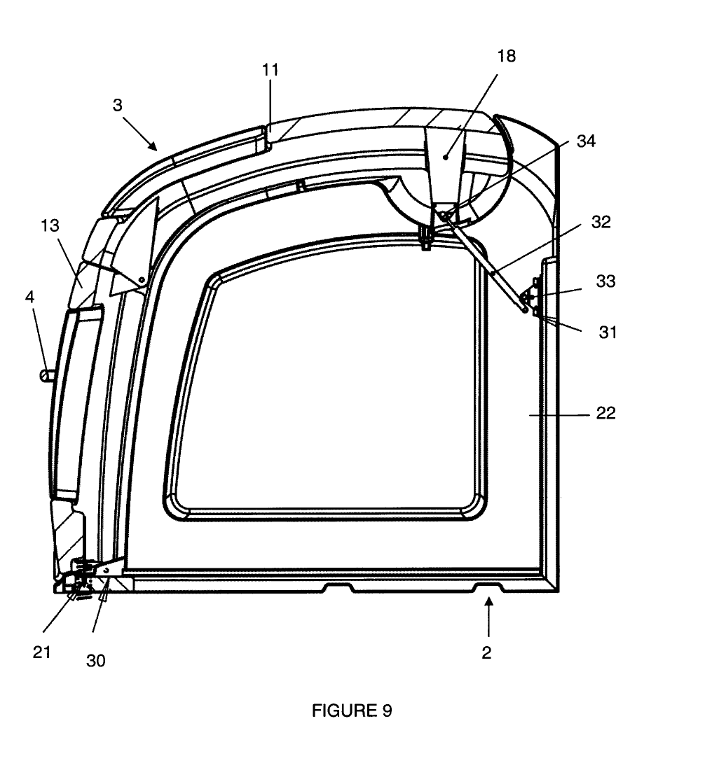

FIG. 9 is a section through the container on the line A-A of FIG. 4; and

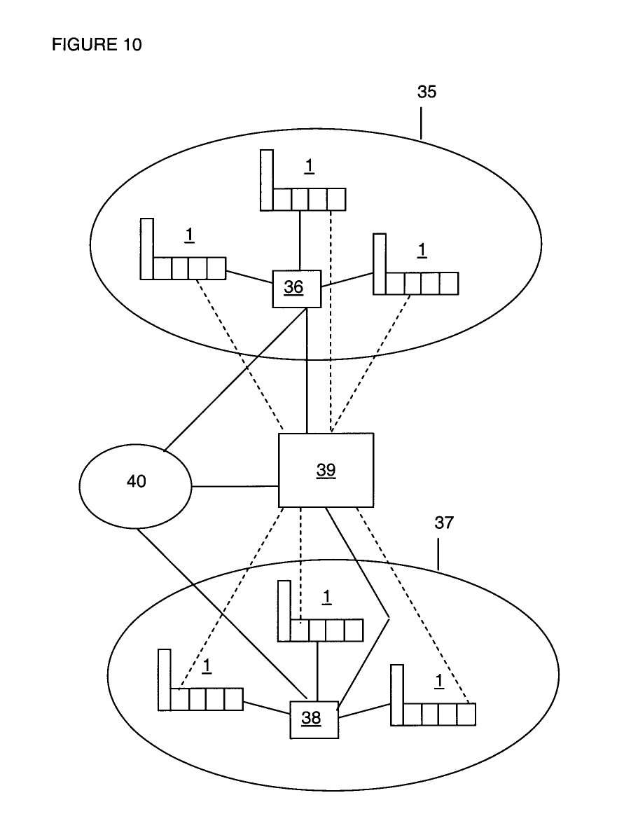

FIG. 10 is a diagram of how access units may be linked through a central data processing system.

Referring now in detail to the figures, in FIG. 1 there is shown an access unit 1 in accordance with the invention. The access unit may be positioned adjacent the disabled parking pays of a car park at a shopping centre, for example, or be positioned in any other desired location, such as adjacent a bus stop, in a football ground or any other sports or entertainment venue, in a park, at an airport and so forth.

The access unit comprises a number of containers or pods 2, in this case five although the number is immaterial. Each container has a door 3 which can be opened to gain access to the interior so that a wheelchair can be taken or returned. Each door 3 has a handle 4. One container 2′ has its door partly open and another container 2″ has its door fully open. The access unit also includes a control module 5. This has a screen 6 for interacting with a user, a keypad 7, a card reader 8 and a loudspeaker/microphone unit 9 so that a user can talk to a support person. The unit is also provided with handles 10 for use by a person who needs support. The control unit communicates with the

With reference to FIG. 2, a customer releases the door 3 of a container 2′ of the access unit 1, by pressing a corresponding button on the keypad 6, in a manner described in more detail below. The door 3 of the selected container 2′ pops open by around 150 mm, illuminating an internal light and triggering a fragrant and/or sanitising spray, under the control of a micro switch described later. This is the door's “intermediate position”. The customer takes hold of the handle 4 on the front of the container and pulls very slightly. The door then rises up to its fully open position under the power of a gas strut described later. This position is shown in the case of the container 2″ in FIG. 3. It can be seen that the door comprises an upper part 11 which is mounted to the to the body of the container at 12 by a transverse hinge, and is mounted to a lower part 13 by a transverse hinge indicated at 14. With the door in this position, the customer has access to a wheelchair 15 within the container. The customer withdraws the wheelchair 15 and then uses the handle 4 to close the container door 3 and it slams to a closed and locked condition. An RFID reader 16 within the container cooperates with an RFID chip 17 on the wheelchair, so that the removal of that particular wheelchair can be detected.

If the customer prefers, the door can be pushed down just as far as its 150 mm intermediate position (where it will stay), and they can then change hands and push down on the lid to close it completely.

On closing, the container light switches off by means of the micro switch.

FIG. 4 shows a container 2 in more detail. As can be seen, the upper door part 11 is provided with a window 16, and the lower door part is provided with a window 17.

FIGS. 5 and 6 show the door 3 in more detail. There is shown the transverse hinge 14 joining together the upper door part 11 and the lower door part 13. At its upper end, the upper door part is provided with a pair of laterally spaced mountings 18 for hinging the door to the main body of the container 2. At the lower end of the lower door part 13, are provided a pair of laterally extending guide pins 19, one on each side. On these guide pins 19 are mounted followers 20. A lock mechanism 21 is provided adjacent the lower end of lower door part 13, in a central position, and this cooperates with a portion 26 on the main body 22 of the container, as described with reference to FIGS. 7 and 8.

The main body 22 of the container 2 is shown in detail in FIGS. 7 and 8. At its upper end are two laterally spaced mountings 23 for receiving portions of the mountings 18 of the door so as the provide a hinge between the door and the main body. A pair of laterally spaced guide tracks 24 are provided, one on each side of the main body. These are adapted to cooperate with the followers 20 on guide pins 19, to control the movement of the door parts when the door is opened or closed. Spaced laterally outwards from the guide track 24 on each side of the main body 22 is a guide surface 25 which is engaged by the outer ends of the guide pins 19. At its lower end, each guide surface 25 is provided with an undercut portion 26. When the door opens to its intermediate position, the ends of the guide pins 19 engage the undercut portions 26, to hold the door in this intermediate position. The user can then pull the handle 4 so that the guide pins move on to the main parts of the guide tracks 24, and the door can be opened fully. In the centre of the bottom of the main body 22 is a latching portion 27 for engagement with the locking mechanism 21 on the door. Within the main body 22 are tracks 28 for guiding a wheelchair into and out of the container. There is also provided a weight sensitive switch 29 which is operated by the weight of a wheelchair in the container to make or break a circuit so as to provide a signal to the control unit, as an alternative way of determining whether a wheelchair is or is not in place, for use instead of or in addition to the RFID reader.

An advantage of having the intermediate position for the door 3 is that it breaks the range of movement required to close the container so that a large movement is divided into two smaller movements. This can be important for less able users. Additionally, as described above, the intermediate position would allow a user to change hands/grip on the container door. The intermediate position also provides a visual signal to the user (who may be standing at distance, by the control unit 5, at the end of the row of containers) that one of the containers is now released/unlocked. There may also be a visual and/or audible indication of the container number to be used. The intermediate position also prevents the container for injuring or frightening anybody passing the containers, by suddenly swinging open to its maximum height having been remotely unlocked.

The up and over, two part door construction has advantages. If a user is still in their wheelchair when they open the container to return it, the up and over mechanism means that they do not have to back away from the door as it opens. In addition, the door opens within the footprint of the container itself to minimise the impact on space, and for example if sited on a pavement or passageway it will not affect passers-by.

FIG. 9 is a section on the line A-A of FIG. 4, showing the container 2 with door 3 in the closed condition. A micro switch 30 is provided on the base of the main body 22, and is engaged by a door portion when the door is in the closed condition. When the door is partially opened, the operation of the micro switch causes a light to come on, and an air freshener to operate. At the rear upper end of the container is provided a gas strut mechanism 31, comprising a gas strut 32 pivotally mounted at its lower end 33 to the main body 22 of the container, and pivotally mounted at its upper end 34 to a lever arm extension of the mounting 18 on the door 3. A gas strut mechanism may be provided on both sides of the container.

The containers are provided with a source of electrical power, which may come from the control unit 5, and also communicate with the control unit 5 to receive control signals to control, for example, the automatic unlocking of the container and to exchange information concerning the return or removal of a wheelchair, the identity of the wheel chair, and so forth.

The container may be of a suitable width to accommodate a wheelchair in a completely erect state, or may be narrower for accommodating a folding wheelchair. A larger container could, for example, accommodate a mobility scooter or other such vehicle.

The general use of the system is as follows. A user becomes aware of the access unit, for example because of a distinctive sign. The user then approaches the unit. Either the user—who may the person with a mobility problem or a carer—or an attendant who is there to help people, then interacts with the control unit. Instructions are read, and a card inserted or a code provided. A button is pressed and the door of a container partially opens as described above. The user completes opening of the door, removes the wheelchair and inspects it. If it is acceptable the user closes the lid and then the wheelchair is used. If the user rejects the wheelchair, it is placed back in the container and the door closed. The user then goes back to the control unit, inserts the same card, and interacts with the control unit to e.g. try another wheelchair in a different container or cancel the operation.

To return a wheelchair, the user enters the same card or punches a code into the control unit. The door of a vacant container opens partially and again there may be a visual/audible indication on the control unit of the container to be used. The door is opened fully, the wheelchair collapsed and inserted in the container, and then the door closed.

The invention is applicable to any venue, and the wheelchair may be provided free of charge or for a fee. Below there will be described an embodiment of the use of the wheelchair in an airport.

A system for use at an airport may combine modified conventional access units located at main terminal entrances, car parks, etc. with “mini-units” located at departure gates. These can integrated through a software reservations and inventory management system. The system in accordance with the invention provides automatic staff-free wheelchair dispensing from designated points of arrival.

The containers will provide compact, highly identifiable, attractive, waterproof, and vandal resistant dispensers designed with airport security in mind.

An advance reservation system, which may be automated, will enable PRMs (persons of reduced mobility) and operators to pre-book by web or phone; PRMs to receive a detailed location map showing locations of the access units; a wheelchair to be automatically reserved at the requested specific location with a time window; data logging of onward and return details; and real-time information as to the location of all mobility aids, enabling quick collection and relocation with minimum staff time and delay as demand effects dictate, and theft and vandalism containment.

To reserve a wheelchair the customer or ticket issuer contacts the system operator, either via telephone or via a web reservation service, identifies the PRM, the flight number, date & time of flight, who they are, and at which access unit they want a chair reserved. If no location is specified the system defaults to main entrance.

The system operator then issues a confirmation of reservation, together with a six digit code that the PRM will use to access the chair or a printed bar code or other machine readable code that can be used to access the chair, and a location map identifying where their chair is reserved. If the PRM does not have a code (i.e. did not reserve or has mislaid the code) the PRM can press the call button on the access unit for connection to ground staff for a code—or if they need assistance in operating the access unit, or for personal assistance. The dedicated web site is PRM accessible and identifies location of all access units.

In one possible embodiment, a chair is reserved from say three hours before the flight until say one hour before the flight (a two hour window). At the same time onward and return information is noted on the system.

Arrival airports that have the access unit service will automatically receive notification—the data is sent directly to the arrival airport's wheelchair system, enabling wheelchair reservation and/or ground staff notification as appropriate. Any airport not served by wheelchair system receives an email advising the arrival data of PRM's.

Inbound, on arrival at a gate, gate ground staff will already have received notification, and so ensure, through the wheelchair data management system, that adequate wheelchairs are at the gate. If inadequate wheelchairs are at hand, the system identifies the nearest location of additional chairs. The mini-box is accessed by ground staff in the same manner as the other access units and can also issue a printed receipt with a six digit access code.

In a preferred embodiment, main terminal and exterior access units are essentially the standard models of the type discussed above, with a standard sanitizing spray and data connection to central computer. Each such access unit may have multiple, for example, ten containers and is freestanding, and uni- or multi-directional. A modular design allows for easy addition or reduction of containers. A container opens when the PRM keys the six digit code into the control panel or uses another identifier such as a boarding pass or credit/debit card. When a chair is removed the identifier automatically updates the central monitor as to its status (number of chairs at that location etc.), and if it is a reserved chair, that the user has collected the chair.

If a wheelchair is identified as faulty (usually by early return), the machine locks that container, notifies central control, and opens another container.

“Mini-containers” at the gates may typically two to three containers, with a simple control box. They will be accessed mostly by ground staff after helping users up or down the ramp from or to the plane. These mini-boxes will have a chair identifier and key entry (as main terminal models) and a receipt & code number printer. On arrival the ground staff give the PRM the receipt & code number. The receipt advises that failure to return the chair to a container may incur a charge.

The code number opens any access unit with an empty container anywhere within the airport for safe return of the chair. In practice some manual collection may be required.

FIG. 10 shows diagrammatically how access units 1 can be linked at a location 35, such as an airport, to a local administration system 36, and/or to each other, and/or to access units 1 at another location 37 such as another airport, and/or to a local administration system 38 at that other location 37, and/or to a central administration system 39 and/or an airline reservation system 40, using suitable data processing equipment and communications systems. The central administration system 39 could link to access units worldwide. The local administration systems or the central administration systems can assist operators of a local system to track the location of wheelchairs, to keep accurate records of available wheelchairs for inventory purposes, to check that wheelchairs of the appropriate type are available at location for customers, and to check that appropriate personnel are available where needed. Other functions of the local or central administration systems could include checking bookings, dealing with problems and exceptions, handling reservations and so forth. Where a customer wishes to have access to a wheelchair at a location that is not a participant in the scheme, an electronic message such as an e-mail could be sent to a suitable authority at the location to ensure that a wheelchair is made available.

It will thus be seen that by means of a system that is integrated with the booking of a flight, or other transportation, a traveller with mobility difficulties can reserve a wheelchair for use at a departure and/or arrival terminal. The wheelchair will be held securely until the person arrives at the terminal, and will then be released by the same form of identification as that which could be used to enable the traveller to use the transportation. The system can be tied in to, for example, the system of airlines, airport operators and so forth.

In general, embodiments of some aspects of the invention provide apparatus for enabling temporary access to a wheelchair, which comprises a number of wheelchair containers and a control unit which communicates with the containers and is arranged to interact with a user to permit release of the wheelchair from the container. Each container may be provided with a reader for an identifier carried by a wheelchair, so that the control unit can record that a wheelchair with that identifier has been released, and record return of that or another wheelchair to the container. The control unit may communicate with the control units of other apparatus at other locations, and/or with a central data processing facility. The system may be integrated with a transport reservation system.

1-28. (canceled)

29. A system for enabling temporary access to mobility assistance vehicles at a plurality of locations, for persons of reduced mobility, comprising a central administration unit and a plurality of mobility assistance vehicles distributed across a plurality of access units in data communication with the central administration unit, there being an access unit at each said location; wherein each access unit comprises a plurality of lockable retaining units each of which is arranged to retain a mobility assistance vehicle, each access unit includes a control module linked to all of the retaining units of that access unit, each mobility assistance vehicle carries a unique machine readable identifier, and each retaining unit includes a reader for reading the machine readable identifier of a mobility assistance vehicle; wherein the control module is configured to (i) receive verification data from a person desiring access to a mobility assistance vehicle and to check the verification data; in the event of successful verification to control unlocking of a retaining unit so as to permit release of a first mobility assistance vehicle from a first retaining unit; and to generate release event data linking the identifier of the first mobility assistance vehicle, provided by the reader of the first retaining unit, with the release from the first retaining unit; and the control module is further configured to (ii) control locking of a second retaining unit after return of a second mobility assistance vehicle to the second retaining unit; and to generate return event data linking the identifier of the second mobility assistance vehicle, provided by the reader of the second retaining unit, with the return of the second mobility assistance vehicle to the second retaining unit.

30. A system as claimed in claim 29 wherein the retaining unit is in the form of a container.

31. A system as claimed in claim 30, wherein the container is provided with a lockable door which can be unlocked under the control of the control module to provide access to the interior of the container to permit removal and replacement of a mobility assistance vehicle.

32. A system as claimed in claim 31, wherein the container has a body with a front wall and a top wall, and the door extends over the top wall and the front wall, wherein the door comprises an upper part and a lower part which are joined together by means of a first transverse hinge, the upper part having a first end portion which is mounted to the body of the container by means of a second transverse hinge, and the lower part having a second end portion provided with means to enable the door to be locked and unlocked to the body portion.

33. A system as claimed in claim 32, wherein means are provided for holding the door in an intermediate open position.

34. A system as claimed in claim 33, wherein the arrangement is such that when the control unit controls the locking means to unlock the door, the door moves to the intermediate open position.

35. A system as claimed in claim 34, wherein the arrangement is such that user manipulation of the door away from the container body permits the door to move from the intermediate open position to a fully open position.

36. A system as claimed in claim 35, wherein power assistance means are provided for moving the door to the fully open position.

37. A system as claimed in claim 29, wherein the mobility assistance vehicles are wheelchairs.

38. A method for enabling temporary access to mobility assistance vehicles at a plurality of locations, for persons of reduced mobility, wherein there is provided a central administration unit and a plurality of mobility assistance vehicles distributed across a plurality of access units in data communication with the central administration unit, there being an access unit at each said location; wherein each access unit comprises a plurality of lockable retaining units each of which is arranged to retain a mobility assistance vehicle, each access unit includes a control module linked to all of the retaining units of that access unit, each mobility assistance vehicle carries a unique machine readable identifier, and each retaining unit includes a reader for reading the machine readable identifier of a mobility assistance vehicle; wherein the control module (i) in a release sequence receives verification data from a person desiring access to a mobility assistance vehicle and checks the verification data; in the event of successful verification controls unlocking of a retaining unit so as to permit release of a first mobility assistance vehicle from a first retaining unit; and generates release event data linking the identifier of the first mobility assistance vehicle, provided by the reader of the first retaining unit, with the release from the first retaining unit; and the control module further (ii) in a return sequence controls locking of a second retaining unit after return of a second mobility assistance vehicle to the second retaining unit; and generates return event data linking the identifier of the second mobility assistance vehicle, provided by the reader of the second retaining unit, with the return of the second mobility assistance vehicle to the second retaining unit.

39. A method as claimed in claim 38, wherein the second mobility assistance vehicle was previously released from a retaining unit of a different access unit.

40. A method as claimed in claim 38, wherein a person pre-books a mobility assistance vehicle to be provided from a selected access unit.

41. A method as claimed in claim 40, wherein the selected access unit is provided at a departure location for the person when travelling, the person wishing to have a mobility assistance vehicle for mobility at the departure location; wherein a booking for the mobility assistance vehicle at the departure location is linked to a reservation for transport from the departure location, and when the user is at the departure location an identifier associated with the transport reservation is used by the control unit as the verification data in order to release the mobility assistance vehicle from a retaining unit.

42. A method as claimed in claim 41, wherein the departure location is an airport.

43. A method as claimed in claim 42, wherein the access unit is provided at an arrival location for the person when travelling, the person wishing to have a mobility assistance vehicle for mobility at the arrival location, wherein a booking for the mobility assistance vehicle at the arrival location is linked to a reservation for transport to the arrival location, and when the user is at the arrival location an identifier associated with the transport reservation is used by the control unit as the verification data to release the mobility assistance vehicle from the retaining unit.

44. A method as claimed in claim 43, wherein the arrival location is an airport.

45. A method as claimed in claim 44 wherein the retaining unit is in the form of a container provided with a lockable door which is unlocked under the control of the control module to provide access to the interior of the container to permit removal and replacement of a mobility assistance vehicle, means are provided for holding the door in an intermediate open position, when the control unit controls the locking means to unlock the door, the door moves to the intermediate open position, and when the door is in the intermediate position, a user manipulates the door and the door moves from the intermediate open position to a fully open position under power assistance.

46. A method as claimed in claim 38, wherein the mobility assistance vehicles are wheelchairs

47. A method of enabling temporary access to a mobility assistance vehicle for a person of reduced mobility, comprising:
(i) providing a first access unit which includes a plurality of lockable retaining units for a respective plurality of mobility assistance vehicles, the access unit including a control unit linked to all of the retaining units, wherein a user interacts with the control unit to provide identification data when desiring access to a mobility assistance vehicle, the control unit controls unlocking of a retaining unit so as to permit release of a mobility assistance vehicle from that retaining unit, and the control unit stores data linking supply of the mobility assistance vehicle with a user associated with the identification data; and
(ii) providing a second access unit which includes a plurality of lockable retaining units for a respective plurality of mobility assistance vehicles, the access unit including a control unit linked to all of the retaining units and controlling locking means for the retaining units, wherein a user interacts with the control unit of the second access unit to provide identification data when returning the mobility assistance vehicle, the user places the mobility assistance vehicle in an empty retaining unit, the retaining unit is locked, and the control unit stores data linking return of the mobility assistance vehicle with a user associated with the identification data.

48. A method as claimed in claim 47, wherein the first access unit and the second access unit are at different locations.
